(19) United States
(12) Patent Application Publication
(10) Pub. No.: US 2008/0276260 A1
(43) Pub. Date: Nov. 6, 2008

(54) Adaptive User Interface Verification

(75) Inventors: Michael S. Garlick, Bothell, WA (US); Michael J. Eatough, Kirkland, WA (US); Adam R. Kenney, Astoria, NY (US); Matthew R. Dorbin, Seattle, WA (US); Michael T. Tucker, Bellevue, WA (US); Sherri L. Duran, Bellevue, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/743,726

(22) Filed: May 3, 2007

(51) Int. Cl. G06F 9/44

(52) U.S. Cl. 719/328

(57) ABSTRACT

User interface verification may be provided. First, a known good file may be received. Next, an automation may be run on an application program to place the application program in a predetermined state. Data from the known good file may then be compared to data corresponding to a user interface corresponding to the predetermined state of the application program. In response to the comparison, results corresponding to comparing the data from the known good file to the data corresponding to the user interface may be reported.

### BACKGROUND

When developing software, programming modules may be tested during the development process. Such testing may produce code coverage data. Code coverage data may comprise metrics that may indicate what code pieces within a tested programming module have been executed during the programming module's test. The code coverage data may be useful in a number of ways, for example, for prioritizing testing efforts. Furthermore, user interfaces corresponding to the programming modules may also need to be tested to make sure that they provide an expected presentation to users.

In order to test the programming modules, developers may include “test hooks” in the programming modules. As software security becomes more and more critical, however, these private test hooks for automation may be removed from the programming modules being developed. Consequently, other ways to test programming modules, including user interfaces, need to be developed.

### SUMMARY

This Summary is provided to introduce a selection of concepts in a simplified form that are further described below in the Detailed Description. This Summary is not intended to identify key features or essential features of the claimed subject matter. Nor is this Summary intended to be used to limit the claimed subject matter's scope.

User interface verification may be provided. First, a known good file may be received. Next, an automation may be run on an application program to place the application program in a predetermined state. Data from the known good file may then be compared to data corresponding to a user interface corresponding to the predetermined state of the application program. In response to the comparison, results corresponding to comparing the data from the known good file to the data corresponding to the user interface may be reported.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of a user interface verification system;

FIG. 2 is a flow chart of a method for providing user interface verification; and

FIG. 3 is a block diagram of a system including a computing device.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

Consistent with embodiments of the invention, a change-tolerant user interface (UI) comparison may be provided. Instead of doing a strict comparison of a known good file (e.g. base comparison file) against a current UI, embodiments of the invention may use an accessibility layer to allow UI validation that can automatically account for a defined change level in the UI. This may be based on examining individual controls on a dialog or other UI to validate that the expected controls are all still present and correctly displayed. This validation may take place even if their order on the dialog has changed or if the UI language that an application is currently running currently is different from the language that was use to create the known good file.

As software security becomes more and more critical, private “test hooks” for automation are being removed from applications. In order to maintain high-quality automations (i.e. automated software tests) for application testing, tests may use published application program interfaces (APIs) to validate applications. For example, user interface (UI) based testing via accessibility layer APIs may be used to access accessibility objects trees to locate a UI elements to be tested. However, manipulating the application in an automated fashion via the accessibility layer may be slow if the test needs to walk through a complex accessibility objects tree to locate a UI element to be tested or manipulated. Consistent with embodiments of the invention, a search tree may be built to identify a particular UI element and to improve the searching speed.

In conventional systems, a tester installs an application, uses the application, and looks at a UI produced by the application to see if anything looks wrong. If there is something that looks wrong, the tester may then attempt to fix it. Consistent with embodiments of the invention, user interface verification may be provided. Most applications have a user interface to make it accessible, for example, to a user with disabilities. For example, most applications have an accessibility layer API that may allow a screen reader or a control system to enable somebody with disabilities to manipulate the computer without a keyboard or a mouse. Embodiments of the invention may provide an overall test architecture system that may both automate and validate that a UI is correct based on the application's accessibility layer. Information provided by the accessibility layer API may allow an adaptive validation consistent with embodiments of the invention.

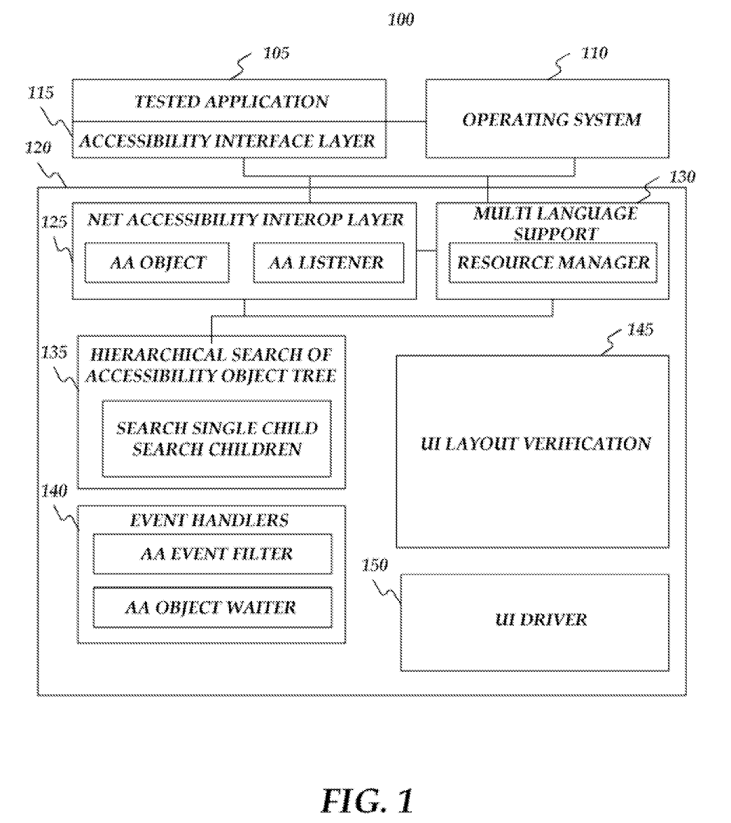

FIG. 1 is a block, diagram of a user interface verification system 100. System 100 may include an application 105, an operating system 110, and an automation and verification application 120. Application 105 may include an accessibility layer 115 automation and verification application 120 may include a net accessibility interop layer 125, a multi language support 130, a hierarchical search of accessibility tree 135, an event handlers 140, a UI layout verification 145, and a UI driver 150.

Net accessibility interop layer 125 may allow net code to access and manipulate an accessible interface defined by operating system 110 or application 105. Multi language support 130 may allow embodiments of the invention to operate under multiple languages. In order to perform comparisons as described below, embodiments of the invention may need to correctly identify localized strings used in a currently installed version of application 105 being test. Embodiments of the invention may utilize language resource files installed, for example, by application 105 to do this. Tests built using embodiments of the invention refer to the strings in application 105 using tokens that may be resolved to the appropriate UI strings by querying the currently installed language resource files for application 105. This may ensure that the test script targets the correct UI element, regardless of the current application language.

Accessibility objects provided by applications may be structured into complex parent/child trees that can be time consuming to traverse. To overcome this, embodiments of the invention may use a hierarchical search of accessibility tree 135 to provide a multi-level hierarchical search that may provide, for example, an XPath-style syntax to the script. This may allow the test writer to quickly describe the UI element they are looking for in a manner that allows for some change in UI layout and structure without causing a script to fail. The search code may use the multi-language support built into the system to automatically translate the search strings into the correct language for the current application install. Event handlers 140 may allow automations to monitor and react to specific events from accessibility layer 155 or from operating system 110. In other words, event handlers 140 may provide a filter for the events to allow the test to monitor and react to just those events that are important to a particular automation.

UI layout verification 145 may prevent UI changes from slipping through unnoticed by recording the state of a specified UI with each build of application 105, and comparing this state against a previous build (e.g. a known good file). It may then provide a report of any changes to the area owner, who may take action accordingly. UI layout verification 145 may validate UI layout and positioning based on an accessibility tree of application, using hierarchical search code, multi-language support 130, and accessibility interop layer 125 to quickly match a current application 105 UI against a recorded known good file structure recorded, for example, in XML.

The known good file may also describe an allowable set of changes (i.e. tolerance.) For example, the known good file may define that control sizes are unimportant, but that relative order of the controls are. An example of this may be in a user interface ribbon. Depending on screen resolution, various controls on the ribbon may be shrunken and rearranged to allow them to display correctly. The known good file may describe an allowed variance (e.g. tolerance) in control size and positioning and not flag these expected changes as a failure. The file may also describe the expected text on the controls in a way that may allow a language independent comparison.

Using bounding rectangles that may be defined by accessibility interface layer 115, UI layout verification 145 may also use bitmap compare code to validate that individual portions of the UI are drawn correctly on a display as well as correctly organized in the accessibility structure. Using character recognition and compare code that may be tolerant to variations around the edges of the compared area, the code can validate that individual UI elements are drawn correctly regardless, for example, of current UI language. In addition to the tolerant comparison of the positions, size, and other properties that can be read from the accessibility interface API, embodiments of the invention may include the ability to use “fuzzy” bitmap comparisons to validate the UI visual rendering. Embodiments of the invention may also provide for some tolerance of UI changes when doing verifications. In other words, embodiments of the invention may verify that all controls are present and drawn correctly on a dialog even if the order of those controls changes. Only the reordering change, for example, may be reported as a difference from the expected target.

UI driver 150 may enable a complex interaction of stages within a test automation to reach a point where the test automation needs to do a verification of application behavior. UI driver 150 may provide a description of the expected UI at each stage and a set of actions to perform on controls to move from stage to stage. This may allow the automation to describe the stages to move through a complex series of UI (e.g. a multi-page wizard in Access) using, for example, XML. UI driver 150 may translate the XML into test actions that operate on the UI. In other words, UI driver 150 may include actions to move through the UI. In addition, UI driver 150 may include UI verification steps to validate that the expected UI changes from the actions have occurred. UI driver 150 may use the verification processes described above to do this.

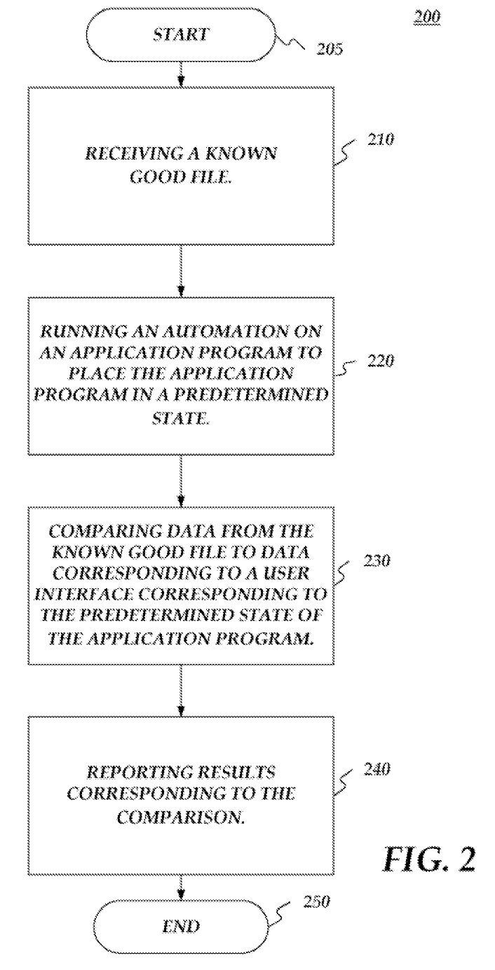

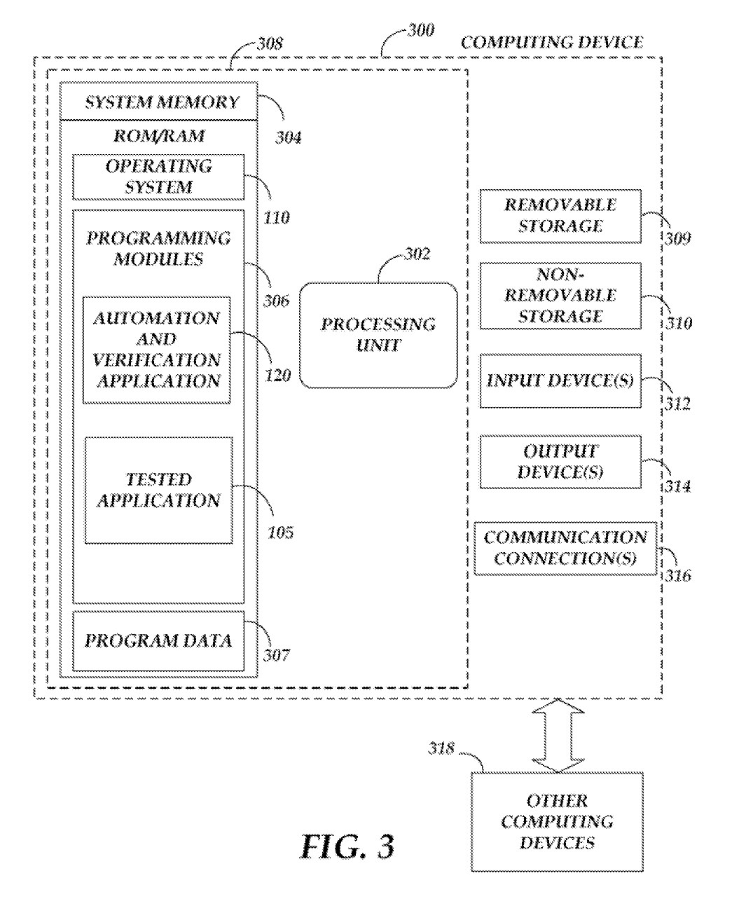

FIG. 2 is a flow chart setting forth the general stages involved in a method 200 consistent with an embodiment of the invention for providing user interface verification. Method 200 may be implemented using a computing device 300 as described in more detail below with respect to FIG. 3. Ways to implement the stages of method 200 will be described in greater detail below. Method 200 may begin at starting block 205 and proceed to stage 210 where computing device 300 may receive a known good file. The known good file may be stored as program data 307 as shown in FIG. 3 described below. For example, the known good file may include first data corresponding to a predetermined state of a user interface corresponding to a first version of an application program 105.

In order to produce the first data, a user may run the first version of application program 105 on computing device 300. While running the first version of application program 105, the user may cause the user interface to be in the predetermined state. In other words, the user interface may be a user interface the user wishes to test. In order to create the know good file, the user may manipulate the first version of application program 105 until the user interface (in the predetermined state) is shown on one of output devices 314 (e.g. a display device) as described below with respect to FIG. 3.

After the user interface (in the predetermined state) is shown on one of output devices 314, the user may produce an indication that the user interface is acceptable. In other words, the user may view the user interface on a display device and determine that the displayed user interface is in a proper state. For example, the user may determine that the needed buttons are present, that they are in the right place, that dialog boxes are the correct size and in the right place, etc. Once the user interface is determined to be acceptable, the user may send an indication (e.g. through one of input devices 312 as described below) to processing unit 302 indicating that the user interface is acceptable. Consequently, the first data corresponding to the user interface produced in response to running the first version of application program 105 may be saved in response to the received indication to the know good file. The first data may be received from accessibility layer 115 of the first version of application program 105. The first date may comprise, but is not limited to an XML file structure.

Computing device 300 may also receive edits to the known good file. The edits may be configured to increase a tolerance between the first data and a second data. The second data may correspond to the user interface produced in response to subsequently running a second version of application program 105. The second version may be version of application 105 that has some code modification. For example, the UI produced by the second version of application program 105 may be described by accessibility layer 115 in terms of position of controls, the labels of those controls, descriptive information about the controls, or the value settings. In other words, the UI produced by the second version of application program 105 may be described by whatever information is considered important for somebody to know about that control. The UI may be described programmatically in accessibility layer 115 so that it can be compared to the known good file to see if it is what is expected.

As stated above, the known good file can be exact or it can be described relatively. As stated above, embodiments of the invention may provide a change-tolerant user interface (UI) comparison. Instead of doing a strict comparison of the known good file (e.g. base comparison file) against a currant UI, embodiments of the invention may use an accessibility layer to allow UI validation that can automatically account for a defined change level in the UI. This may be based on examining individual controls on a dialog or other UI to validate that the expected controls are all still present and correctly displayed. This validation may take place even if their order on the dialog has changed or if the UI language that an application is currently running currently is different from the language that was used to create the known good file. For example, the positions of these controls may be described in the known good file where that are expected to be or a certain amount of tolerance may be reflected in the known good file. For example, the size of a control may have a size range or the position may not matter, just the fact that the control is present. Also, unlike conventional bitmap comparisons, language may not matter with embodiments of the present invention. For example, the first version used to create the known good file may use English, but the second version being tested use Japanese. In this example, the button layout would be the same no matter the language and a comparison would correctly show no variation. However, a conventional bitmap comparison would fail in this instance. In other words, embodiments of the invention may be tolerant of some difference and may be able to report that the controls are where they are expect to be, they are the sizes expect, they contain the data expect, and they look like they are expected to look.

As stated above, the edits may be configured to increase a tolerance between the first data and the second data. For example, the user may go through and make some changes to the known good file to remove a little bit of data. This data removal/edit may be done to allow the tolerance because the original known good file may captures all of the data as strictly as it can. Creating the tolerance may allow the user to go through the known good file and say, for example, I do not care about a particular item so I will add some tolerance. The user may also define acceptable change deltas or tolerances. For example, the control size can be set to allow variance within a specified rage, but size changes outside that range may still be considered a failure.

From stage 210, where computing device 300 receives the known good file, method 200 may advance to stage 220 where computing device 300 may run an automation on application program 105 to place application 105 in a predetermined state. For example, as stated above, application 105's source code may be modified during the development process to create the second version of application program 105. To insure that UIs in the modified (i.e. second) version are still acceptable, the automation may run the second version of the application program and interact with it with a certain input sequence. This input sequence produced by the automation may be configured to cause application program 105 to be placed in the predetermined state. For example, the automation may cause a certain UI to be produced by application 105 and available at accessibility layer 115 of the second version of application 105.

Once computing device 300 runs the automation in stage 220, method 200 may continue to stage 230 where computing device 300 may compare data from the known good file to data corresponding to a UI corresponding to the predetermined state of the second version of application program 105. For example, as stated above, the known good file may include data describing the UI in an acceptable state. The data produced by the automation may describe the same UI as produced by a modified (or second) version of application program 105. These two data sets may be compared to see if the modification to application program 105 changed the UI beyond an acceptable level as compared to the known good file. For example, embodiments of the invention may walk through the data produced by the automation and determine that there is a print button and that the known good file shows that the print button should be present. Then the remainder of the data produced by the automation may be walked through and compared in a similar way.

The data produced by the automation may be available at accessibility layer 115 and may be stored in a memory system memory 304 (as described below) in an accessibility object tree. The known good file may also include data indicating where in the accessibility object tree the data corresponding to the UI begins. The data indicating where in the accessibility object tree the data corresponding to the UI begins may also be obtain from other sources.

After computing device 300 compares the data from the known good file in stage 230, method 200 may proceed to stage 240 where computing device 300 may report, in response to comparing, results corresponding to comparing the data from the known good file to the data corresponding to the user interface. For example, the report may contain results indicating that the user interface as produced by the second version of application program 105 is acceptable. Furthermore, the results may indicate that the user interface as produced by the second version of application program 105 is different from the user interface as produced by the first version of application program 105. Moreover, the results may indicate differences between the user interface as produced by the second version of application program 105 and the user interface as produced by the first version of application program 105. The report may be produced to any of output devices 312 as described below. Once computing device 300 reports the results in stage 240, method 200 may then end at stage 250.

An embodiment consistent with the invention may comprise a system for providing user interface verification. The system may comprise a memory storage and a processing unit coupled to the memory storage. The processing unit may be operative to receiving a known good file and to run an automation on a second version of an application program to place the application program in a predetermined state. In addition, the processing unit may be operative to compare first data from the known good file to second data corresponding to a user interface corresponding to the predetermined state of the application program. In addition, the processing unit may be operative to report, in response to comparing, results corresponding to comparing the first data to the second data.

Another embodiment consistent with the invention may comprise a system for providing user interface verification. The system may comprise a memory storage and a processing unit coupled to the memory storage. The processing unit may be operative to run a first version of an application program and to receive an indication that a user interface produced by the application program is acceptable. In addition, the processing unit may be operative to save, into a known good file, data corresponding to the user interface.

FIG. 3 is a block diagram of a system including computing device 300. Consistent with an embodiment of the invention, the aforementioned memory storage and processing unit may be implemented in a computing device, such as computing device 300 of FIG. 3. Any suitable combination of hardware, software, or firmware may be used to implement the memory storage and processing unit. For example, the memory storage and processing unit may be implemented with computing device 300 or any of other computing devices 318, in combination with computing device 300. The aforementioned system, device, and processors are examples and other systems, devices, and processors may comprise the aforementioned memory storage and processing unit, consistent with embodiments of the invention. Furthermore, computing device 300 may comprise an operating environment for system 100 as described above. System 100 may operate in other environments and is not limited to computing device 300.

With reference to FIG. 3, a system consistent with an embodiment of the invention may include a computing device, such as computing device 300. In a basic configuration, computing device 300 may include at least one processing unit 302 and a system memory 304. Depending on the configuration and type of computing device, system memory 304 may comprise, but is not limited to, volatile (e.g. random access memory (RAM)), non-volatile (e.g. read-only memory (ROM)), flash memory, or any combination. System memory 304 may include operating system 110, one or more programming modules 306, and may include a program data 307. Operating system 110, for example, may be suitable for controlling computing device 300's operation. In one embodiment, programming modules 306 may include automation and verification application 120 and tested application 105. Furthermore, embodiments of the invention may be practiced in conjunction with a graphics library, other operating systems, or any other application program and is not limited to any particular application or system. This basic configuration is illustrated in FIG. 3 by those components within a dashed line 308.

Computing device 300 may have additional features or functionality. For example, computing device 300 may also include additional data storage devices (removable and/or non-removable) such as, for example, magnetic disks, optical disks, or tape. Such additional storage is illustrated in FIG. 3 by a removable storage 309 and a non-removable storage 310. Computer storage media may include volatile and nonvolatile, removable and non-removable media implemented in any method or technology for storage of information, such as computer readable instructions, data structures, program modules, or other data. System memory 304, removable storage 309, and non-removable storage 310 are all computer storage media examples (i.e. memory storage). Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 300. Any such computer storage media may be pad of device 300. Computing device 300 may also have input device(s) 312 such as a keyboard, a mouse, a pen, a sound input device, a touch input device, etc. Output device(s) 314 such as a display, speakers, a printer, etc. may also be included. The aforementioned devices are examples and others may be used.

Computing device 300 may also contain a communication connection 318 that may allow device 300 to communicate with other computing devices 318, such as over a network in a distributed computing environment, for example, an intranet or the Internet. Communication connection 316 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 304, including operating system 110. While executing on processing unit 302, programming modules 306 (e.g. automation and verification application 120) may perform processes including, for example, one or more method 200's stages as described above. The aforementioned process is an example, and processing unit 302 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicant. The Applicant retains and reserves all rights in the code included herein, and grants permission to reproduce the material only in connection with reproduction of the granted patent and for no other purpose. While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. A method for providing user interface verification, the method comprising:
receiving a known good file;
running an automation on a second version of an application program to place the application program in a predetermined state;
comparing first data from the known good file to second data corresponding to a user interface corresponding to the predetermined state of the application program, the first data configured to include a tolerance between the first data and the second data; and
reporting, in response to comparing, results corresponding to comparing the first data to the second data.

2. The method of claim 1, wherein receiving the known good file comprises receiving the known good file including the first data corresponding to a first version of the application program in the predetermined state of the user interface.

3. The method of claim 1, further comprising:
running a first version of the application program;
receiving an indication that a user interface produced in response to running the first version of the application program is acceptable; and
saving, in the known good file in response to receiving the indication, the first data corresponding to the user interface produced in response to running the first version of the application program.

4. The method of claim 3, wherein saving, in the known good file, the first data comprises saving, in the known good file, the first data being received from an accessibility layer of the first version of the application program.

5. The method of claim 3, wherein receiving the indication comprises receiving the indication in response to a user indicated input.

6. The method of claim 3, further comprising receiving edits to the known good file, the edits configured to increase the tolerance between the first data and the second data.

7. The method of claim 1, wherein reporting the results comprises reporting the results indicating that the user interface as produced by the second version of the application program is acceptable.

8. The method of claim 1, wherein reporting the results comprises reporting the results indicating that the user interface as produced by the second version of the application program is different torn the user interface as produced by the first version of the application program.

9. The method of claim 1, wherein reporting the results comprises reporting the results indicating differences between the user interface as produced by the second version of the application program and the user interface as produced by the first version of the application program.

10. The method of claim 1, wherein comparing the first data from the known good file to the second data corresponding to the user interface corresponding to the predetermined state of the application program comprises receiving the second data being produced by an accessibility layer of the second version of the application program.

11. The method of claim 1, wherein comparing the first data from the known good file to the second data corresponding to the user interface corresponding to the predetermined state of the application program comprises comparing the first data from the known good file to the second data located in an accessibility object tree in a computer memory.

12. The method of claim 11, further comprising receiving data indicating where in the accessibility object tree the second data begins.

13. The method of claim 1, wherein comparing the first data from the known good file to the second data corresponding to the user interface corresponding to the predetermined state of the application program comprises comparing the first data from the known good file to the second data located in an accessibility object tree in a computer memory, wherein the known good file includes data indicating where in the accessibility object tree the second data begins.

14. A computer-readable medium which stores a set of instructions which when executed performs a method for providing user interface verification, the method executed by the set of instructions comprising:
running a first version of an application program;
receiving an indication that a user interface produced by the first version of the application program is acceptable; and
saving, in a known good file, data corresponding to the user interface produced by the first version of the application program, the data in the known good file having a tolerance between the data in the known good file and other data corresponding to the user interface.

15. The computer-readable medium of claim 14, wherein saving, in the known good file, the data corresponding to the user interface comprises saving, in the known good file, the data corresponding to the user interface received from an accessibility layer of the first version of the application program.

16. The computer-readable medium of claim 14, wherein receiving the indication comprises receiving the indication in response to a user indicated input.

17. The computer-readable medium of claim 14, further comprising receiving edits to the known good file, the edits configured to increase the tolerance between the data in the known good file and the other data corresponding to the user interface corresponding to a predetermined state of a second version of the application program.

18. A system for providing user interface verification, the system comprising:
a memory storage; and
a processing unit coupled to the memory storage, wherein the processing unit is operative to:
run an automation on a second version of an application program to place the second version of the application program in a predetermined state;
compare first data from a known good file to second data corresponding to a user interface corresponding to the predetermined state of the second version of the application program, the first data configured to include a tolerance between the first data and the second data; and
report results corresponding to comparing the first data to the second data.

19. The system of claim 18, further comprising the processing unit being operative to:
run a first version of the application program;
receive an indication that a user interface produced in response to running the first version of the application program is acceptable; and
save, in the known good file, date corresponding to the user interface produced in response to running the first version of the application program.

20. The system of claim 19, wherein the processing unit being operative to receive the indication comprises the processing unit being operative to receive the indication in response to a user indicated input.
